(19) United States
(12) Patent Application Publication
(10) Pub. No.: US 2006/0222106 A1
(43) Pub. Date: Oct. 5, 2006

(54) Method for detecting single frequency tones

(76) Inventors: James L. Seidman, Naperville, IL (US); Douglas Todd Rylaarsdam, Lombard, IL (US)

Correspondence Address: WELSH & KATZ, LTD, 120 S RIVERSIDE PLAZA, 22ND FLOOR, CHICAGO, IL, 60606, US

(21) Appl. No.: 11/098,074

(22) Filed: Apr. 4, 2005

(51) Int. Cl. H04L 27/00

(52) U.S. Cl. 375/316

(57) ABSTRACT

A method and apparatus are provided for detecting a relatively constant frequency signal on a communication channel. The method includes the steps of detecting sign changes of the signal on the channel and determining that the signal is substantially the only signal present on the channel when an average time interval between positive-going sign changes substantially equals an average time interval between negative-going sign changes.

### FIELD OF THE INVENTION

The field of the invention relates to communication systems and more particularly to the detection of status signals on communication channels.

### BACKGROUND OF THE INVENTION

There are many situations in which it is necessary to detect the presence and frequency of a tone within an audio stream present on a communication channel. For example, where a telephone call is placed to certain destinations, the call may be answered by an automated system that will respond with a tone. Examples of this situation would include a call to a facsimile machine, a modem, or even the special information tones (SIT) generated by the telephony network itself.

Traditional digital methods of detecting tones have included sampling the audio stream from the communication channel and processing the samples to detect any signals present. A Fast Fourier Transform (FFT) may be performed on the samples. Any signals present on the channel may appear as peaks within the FFT representation of the signal.

While the detection of tones based upon an FFT is effective, the evaluation of FFTs is computationally intensive. The computational load is exacerbated by the fact that streams are often encoded using a compression algorithm (e.g., the standard G.711 codec). Because of the importance of communications, a need exists for a method of detecting signals that is less computationally intensive.

### SUMMARY

A method and apparatus are provided for detecting a relatively constant frequency signal on a communication channel. The method includes the steps of detecting sign changes of the signal on the channel and determining that the signal is substantially the only signal present on the channel when an average time interval between positive-going sign changes substantially equals an average time interval between negative-going sign changes.

### BRIEF DESCRIPTION OF THE DRAWINGS

FIG. 1 is a block diagram of a tone detector in accordance with an illustrated embodiment of the invention;

FIG. 2 depicts samples of a tone that may be collected by the system of FIG. 1; and

FIG. 3 is a flow chart of process steps that may be used by the system of FIG. 1.

### DETAILED DESCRIPTION OF THE ILLUSTRATED EMBODIMENT

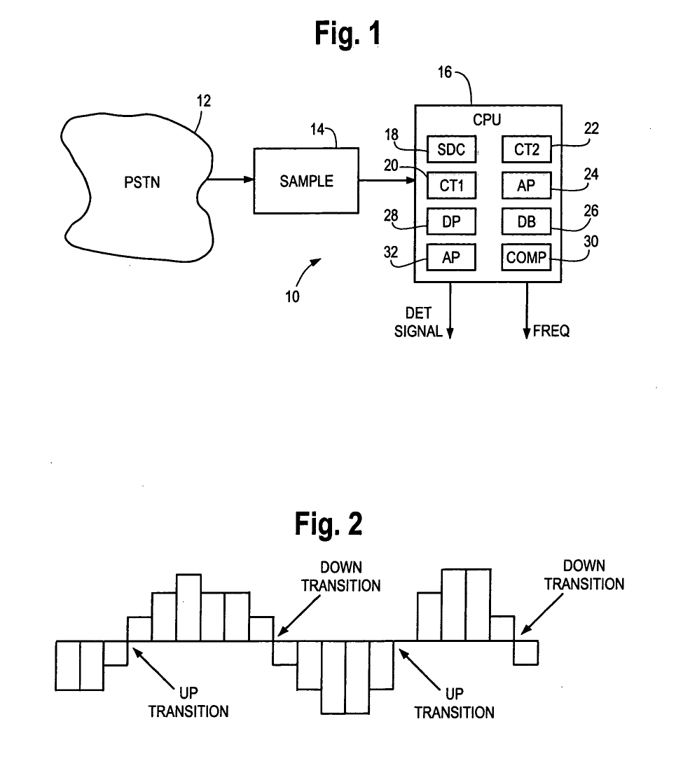

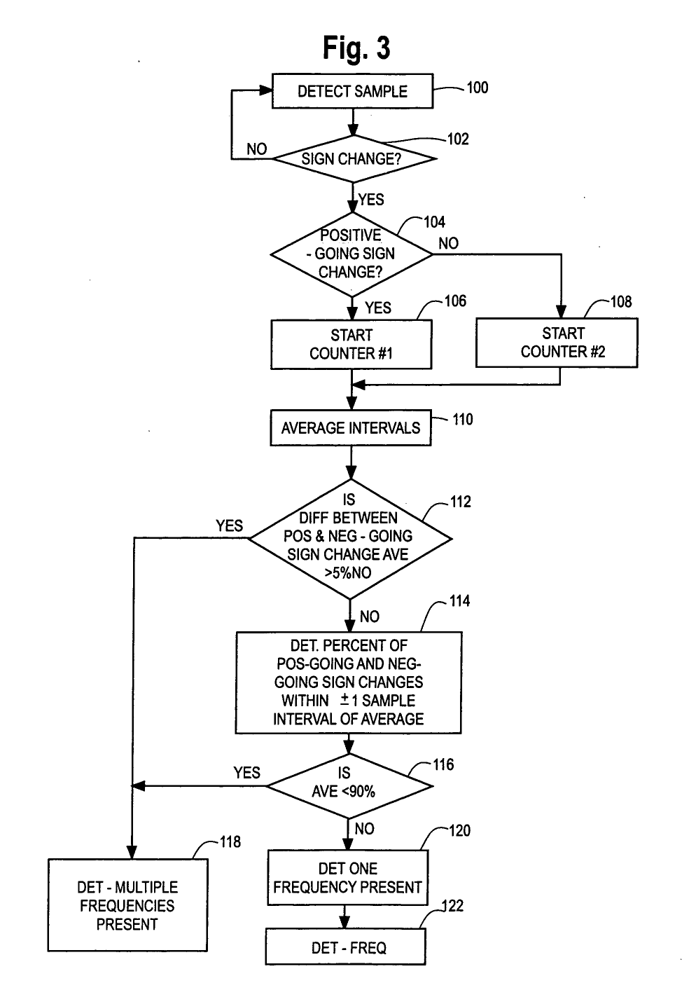

FIG. 1 is a simplified block diagram of a tone detector 10 shown generally in accordance with an illustrated embodiment of the invention. FIG. 3 is a flow chart of process steps that the detector 10 of FIG. 1 may follow.

Under one illustrated embodiment, the tone detector 10 may be used to detect tones on a switched circuit channel (telephone connection) through the public switch telephone network (PSTN) 12. Under other embodiments, the tone detector 10 may be used to detect tones on virtually any other type of communication channel. As used herein, a signal imposed on a communication channel means a frequency imposed on the channel. It does not mean the channel itself or a carrier the forms the channel.

The tone detector 10 may be used to detect the presence and frequency of a tone. In addition to detecting the presence and frequency of a tone, the detector 10 may also function to verify that the detected tone is the only tone (signal) present on the channel.

In analog circuits, a sampling device 14 may be used to sample the communication connection under the appropriate Nyquist criteria. In other systems, the signal may have been previously sampled as part of the signal transmission process and provided under an appropriate digital format (e.g., G.711).

The G.711 codec is similar to many other codecs in that it uses a representation approach similar to floating point numbers. For G.711, each 8-bit sample may follow the format shown below.

| | | |
|---|---|---|
| Bit 1: | Bits 2-4: | Bits 5 to 8: |
| Sign(p | Segment | Level within a |
| bit) | number (s | segment (1 |
| | bits) | bits) |

The segment number (bits 2-4) is similar to a floating point exponent, and the level number (bits 5-8) similar to a mantissa. G.711 includes two different encoding schemes, A-law and p-law, which differ in how they assign segments, but have essentially equivalent functionality. Using the example of A-law, if the level is taken to be between 0 and 15, inclusive, and the segment between 0 and 7, inclusive, then the magnitude of a sample would be provided by solving the equation, m=(16+1)2^{s}.

Rather than actually decoding the samples in the signal, the tone detector 10 proceeds in an entirely different manner. To detect tones, a sign detection processor 18 within the detector 10 detects changes in the sign bit 102. In this regard, a sign change of a signal occurs when a magnitude of the signal passes through a zero signal level from a positive signal value to a negative signal value or visa versa.

The sign detection processor 18 may determine 104 a direction of the sign change and activate 106, 108 one of two counters 20, 22 to measure the time (i.e., the number of samples) between transitions. For example, FIG. 2 graphically shows a set of sample values of a waveform. In the fragment of samples shown in FIG. 2, there are two positive-going (up transitions) in which the sign of the samples of the waveform changes from negative to positive, and two negative-going (down transitions) in which the sign changes from positive to negative.

In the case of a single-frequency tone, the number of samples between adjacent up transitions will be relatively constant, as will the number of samples between adjacent down transitions. There will typically be some amount of variability in the number of samples between transitions both because of line noise and because of the sampling rate.

In this regard, it has been determined that multi-frequency signals are asymmetric around zero-crossing points. Therefore, the detector 10 can detect whether a series of audio samples represents a single-frequency tone by checking whether the majority of the transitions in each direction are consistently spaced. If the detector 10 determines that the series is of a single-frequency, the detector 10 can then determine what that frequency is by taking the average number of samples between transitions in a given direction, and dividing that number into the sample rate. For example, if the average number of samples between same-direction transitions is 6.7, and the sample rate is the telephony standard of 8000 samples per second, then the frequency would be (8000/6.7)=1194 Hz.

The following describes an exemplary approach used by the detector 10 to analyze a series of samples. The sign detection processor 18 of the detector 10 scans all of the samples in the series, detecting each place where a sign transition occurs. As it finds each transition, the sign detection processor 18 may activate a first counter 20 for positive-going sign changes (up transitions) and a second counter 22 for negative-going sign changes (down transitions). Each time a transition is detected, the sign detection processor 18 retrieves the value from the counter 20, 22, resets the counter 20, 22 and transfers the retrieved counter value to an averaging processor 24.

As an alternative, the counters 20, 22 may simply be timers that count the time between transitions. Either method can be effectively used.

The averaging processor 24 may calculate the number of samples (i.e., the time) between this transition and the previous transition in the same direction. It keeps two sets of counts in a database 26, one for each direction of transition and of how many times the number of samples between the two transitions was any given size. (That is, it counts how many times transitions in a certain direction were 6 samples apart, 7 samples apart, etc.)

Based on the counts collected, the average number of samples between transitions is determined 110 by the averaging processor 24 for both up and down transitions. This number may be different for the two different directions.

A distribution processor 28 may determine a weighted average percent of up transitions by totaling all of the transitions during a particular time period that were plus or minus one sample period from the calculated up transition average and dividing by the total number of up transitions. This process may be repeated for the down transitions and the results transferred to a comparator 30. If the comparator 30 determines that these weighted averages for the up and down direction differ 112 by at least 5%, the detector 10 may determine 118 that this is not a single-frequency signal.

For each transition direction, the distribution processor 28 of the detector 10 may determines the clustering of transitions. In this case, the averaging processor may total all of the up transitions that were within plus or minus one sample period from the average and then determine 116 whether this total includes at least 90% of the total transitions. If this number is less than 90% for either type of transition, the platform determines 118 that this is not a single-frequency signal.

If the cluster of transitions around the up transition average and down transition average does contain at least 90% of the transitions, then the detector 10 may determine 120 that the channel contains a single frequency tone. The detector 10 may then determine a frequency of the tone.

To determined frequency 122, an arithmetic processor 32 within the detector 10 may perform a simple arithmetic average of the two sets of transition data. It then divides this number into the sample rate (typically 8000 samples per second) to calculate the frequency in Hertz.

A specific embodiment of method and apparatus for detecting tones in a communication system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of detecting a relatively constant frequency signal on a communication channel, such method comprising:
detecting sign changes of the signal on the channel; and
determining that the signal is substantially the only signal present on the channel when an average time interval between positive-going sign changes substantially equals an average time interval between negative-going sign changes.

2. The method of detecting the signal as in claim 1 further comprising determining the frequency of the signal from an average time interval between sign changes.

3. The method of detecting the signal as in claim 1 wherein the step of detecting the signal further comprises sampling the signal at a predetermined sampling interval.

4. The method of detecting the signal as in claim 1 wherein the step of detecting the sign change further comprises reading a sign bit of each signal sample.

5. The method of detecting the signal as in claim 1 further comprising activating a first counter each time a first positive-going sign change occurs and deactivating the first counter when a first following positive-going sign change occurs to provide a positive-going sign change interval.

6. The method of detecting the signal as in claim 5 further comprising activating a second counter each time a first negative-going sign change occurs and deactivating the first counter when a first following negative-going sign change occurs to provide a negative-going sign change interval.

7. The method of detecting the signal as in claim 6 further comprising averaging a set of positive-going sign change intervals to provide an average time interval between positive-going sign changes.

8. The method of detecting the signal as in claim 7 further comprising averaging a set of negative-going sign change intervals to provide an average time interval between negative-going sign changes.

9. The method of detecting the signal as in claim 8 further comprising determining that the signal is not an only signal on the channel when the average time interval between the positive-going and negative-going sign changes differs by a predetermine threshold.

10. The method of detecting the signal as in claim 8 further comprising determining a percentage of time that the interval between positive-going sign changes is within plus or minus one sample interval of the average interval between positive-going sign changes or a percentage of time that the interval between negative-going sign changes is within plus or minus one sample interval of the average interval between negative-going sign changes.

11. The method of detecting the signal as in claim 10 further comprising determining that the signal is not the only signal on the channel when the determined percentage is less than a preselected threshold.

12. An apparatus for detecting a relatively constant frequency signal on a communication channel, such apparatus comprising:
means for detecting sign changes of the signal on the channel; and
means for determining that the signal is substantially the only signal present on the channel when an average time interval between positive-going sign changes substantially equals an average time interval between negative-going sign changes.

13. The apparatus of detecting the signal as in claim 12 further comprising means for determining the frequency of the signal from an average time interval between sign changes.

14. The apparatus of detecting the signal as in claim 12 wherein the means for detecting the signal further comprises means for sampling the signal at a predetermined sampling interval.

15. The apparatus of detecting the signal as in claim 12 wherein the means for detecting the sign change further comprises means for reading a sign bit of each signal sample.

16. The apparatus of detecting the signal as in claim 12 further comprising means for activating a first counter each time a first positive-going sign change occurs and deactivating the first counter when a first following positive-going sign change occurs to provide a positive-going sign change interval.

17. The apparatus of detecting the signal as in claim 16 further comprising means for activating a second counter each time a first negative-going sign change occurs and deactivating the first counter when a first following negative-going sign change occurs to provide a negative-going sign change interval.

18. The apparatus of detecting the signal as in claim 17 further comprising means for averaging a set of positive-going sign change intervals to provide an average time interval between positive-going sign changes.

19. The apparatus of detecting the signal as in claim 18 further comprising means for averaging a set of negative-going sign change intervals to provide an average time interval between negative-going sign changes.

20. The apparatus of detecting the signal as in claim 19 further comprising means for determining that the signal is not an only signal on the channel when the average time interval between the positive-going and negative-going sign changes differs by at least 5 percent.

21. The apparatus of detecting the signal as in claim 20 further comprising means for determining a percentage of time that the interval between positive-going sign changes is within plus or minus one sample interval of the average interval between positive-going sign changes or a percentage of time that the interval between negative-going sign changes is within plus or minus one sample interval of the average interval between negative-going sign changes.

22. The apparatus of detecting the signal as in claim 21 further comprising means for determining that the signal is not the only signal on the channel when the determined percentage is less then ninety percent.

23. An apparatus for detecting a relatively constant frequency signal on a communication channel, such apparatus comprising:
a sign detection processor that detects sign changes of the signal on the channel; and
a comparator that determines that the signal is substantially the only signal present on the channel when an average time interval between positive-going sign changes substantially equals an average time interval between negative-going sign changes.

24. The apparatus of detecting the signal as in claim 23 further comprising an arithmetic processor that determines the frequency of the signal from an average time interval between sign changes.

25. The apparatus of detecting the signal as in claim 23 further comprises a sampler that samples the signal at a predetermined sampling interval.

26. The apparatus of detecting the signal as in claim 23 further comprising a first counter that is activated each time a first positive-going sign change occurs and reset when a first following positive-going sign change occurs to provide a positive-going sign change interval.

27. The apparatus of detecting the signal as in claim 26 further comprising means a second counter that is activated each time a first negative-going sign change occurs and reset when a first following negative-going sign change occurs to provide a negative-going sign change interval.

28. The apparatus of detecting the signal as in claim 27 further comprising an averaging processor that averages a set of positive-going sign change intervals to provide an average time interval between positive-going sign changes.

29. The apparatus of detecting the signal as in claim 28 further comprising an averaging processor that averages a set of negative-going sign change intervals to provide an average time interval between negative-going sign changes.

30. The apparatus of detecting the signal as in claim 29 further comprising a comparator that determines that the signal is not an only signal on the channel when the average time interval between the positive-going and negative-going sign changes differs by a predetermined threshold.
